(19) United States
(12) Patent Application Publication
(10) Pub. No.: US 2005/0252206 A1
(43) Pub. Date: Nov. 17, 2005

(54) Buoyancy motor

(76) Inventors: Don Holmevik, Prince Albert (CA); Gordon Evans, Prince Albert (CA)

Correspondence Address: Ryan W Dupuls;Ade & Company, 1700 360 Main Street, Winnipeg Manitoba, R3C 3Z3, CA

(21) Appl. No.: 10/521,816

(22) PCT Filed: Aug. 1, 2003
(86) PCT No.: PCT/CA03/01134

§ 371 Date: Jan. 21, 2005

Related U.S. Application Data
(60) Provisional application No. 60/400,708, filed on Aug. 5, 2002.

(51) Int. Cl. F03C 1/00; F03B 1/00; F04D 29/00; F03D 1/00; F03B 13/12

(52) U.S. Cl. 60/495; 415/52.1; 290/53

(57) ABSTRACT

An engine device (10) consumes air under pressure to produce usable mechanical power. The device includes a wheel (28) rotatably supported within a tank of fluid (52). A plurality of pockets (40) at spaced positions about a periphery of the wheel are selectively filled with gas on a rising side (30) of the wheel and evacuated of gas on the falling side (32) of the wheel such that buoyancy of gas in the pockets on the rising side of the wheel causes rotation of the wheel to produce usable power at a power take-off shaft (24) of the wheel.

### FIELD OF THE INVENTION

The present invention relates to an engine device which consumes air under pressure to produce rotary mechanical power.

### BACKGROUND

Various types of machinery require power for operation. Engines used for generating this power usually consume non-renewable energy sources such as wood, coal, petroleum products and the like. Due to the finite supply of such non-renewable energy sources, the use of engines which consume renewable energy sources is desired for continued operation so as not to deplete the non-renewable energy sources.

### SUMMARY

According to the present invention there is provided an engine device comprising:

a wheel supported for rotation in a working direction about a generally horizontal wheel axis, defining a rising side and a falling side of the wheel as the wheel rotates;

a plurality of pockets at spaced positions about a periphery of the wheel;

a tank surrounding the wheel for containing a fluid about the wheel;

means to introduce gas into the pockets on the rising side of the wheel;

means to remove gas from the pockets on the falling side of the wheel;

and a power take-off shaft coupled to the wheel for rotation with the wheel about the wheel axis;

whereby buoyancy of gas in the pockets on the rising side of the wheel causes rotation of the wheel in the working direction to produce usable power at the power take-off shaft.

The consumption of compressed gas for operation of the engine produces considerable power without consuming non-renewable energy sources.

The pockets are preferably spaced radially outward from the shaft to increase the moment acting on the shaft due to buoyancy of the pocket. Each pocket preferably tapers radially inwardly towards a leading side thereof to reduce drag as the wheel rotates through the surrounding fluid.

The pockets may be collapsible to further reduce drag. In this instance, each pocket preferably comprises a stiff outer panel coupled to the periphery of the wheel by flexible side members permitting the stiff outer panel to be displaced between an expanded position of the pocket in which the panel is spaced from the periphery of the wheel and a collapsed position of the pocket in which the panel is directly adjacent the periphery of the wheel.

When the shaft is arranged to extend through a wall of the tank, preferably there is provided a sealing member connected between the wall and the shaft.

The tank may have an outer wall which is generally cylindrical about the wheel axis, spaced outwardly from the periphery of the wheel.

The means to introduce gas into the pockets preferably comprises a source of gas under pressure which selectively communicates with each of the pockets.

There may be provided a solenoid valve communicating between each pocket and the source of gas under pressure with suitable control means to operate the electric solenoid valves.

The wheel may include a plurality of radially extending tubes communicating between the pockets and the source of gas under pressure at a centre of the wheel. In this instance, the source of gas under pressure preferably communicates through a shaft of the wheel.

In one embodiment, the tank is supported for rotation about the wheel axis. In this instance, the pockets are preferably sealed with respect to fluid in the surrounding tank. The means to introduce gas into the pockets and the means to remove gas from the pockets preferably each comprise tubes communicating gas externally from the wheel.

More particularly, the means to remove gas from the pockets in this embodiment may comprise a source of vacuum pressure which selectively communicates with the pockets. A solenoid valve preferably communicates between each pocket and the source of vacuum pressure.

The means to introduce gas into the pockets may further include an inlet bore at one end of the shaft of the wheel communicating with the pockets via selected ones of the tubes and the means to remove gas from the pockets may further include an outlet bore at an opposing end of the shaft of the wheel communicating with the pockets via selected other ones of the tubes.

According to a second embodiment, the means to remove gas from the pockets comprises an outlet vent in each pocket located at a trailing end thereof. The tank in this instance is preferably fixed relative to the ground with the wheel being rotatable within the tank.

There may be provided a gas collector at a top end of the tank for collecting gas released by the pockets into the fluid contained in the tank.

In a preferred embodiment, the fluid in the tank comprises water because of convenience of availability and low cost, however in further embodiments, the tank may be filled with a fluid having a freezing point below that of water, or a fluid which is denser than water, such as salt water or heavy water. The fluid may also be heated by a suitable heating mechanism in the tank.

In yet further embodiments, there may be provided an electromagnetic coil supported on the wheel and means for generating a surrounding magnetic field in the tank for generating a current when the wheel is rotated. In other arrangements, the wheel may be electrically insulated from a surrounding environment, so that there may be provided an electrical storage device in communication with the wheel for collecting accumulation of static charges from the wheel.

### BRIEF DESCRIPTION OF THE DRAWINGS

In the accompanying drawings, which illustrate exemplary embodiments of the present invention:

FIG. 1 is a partly sectional side elevational view of a first embodiment of the engine device.

FIG. 2 is a top plan view of the engine device according to FIG. 1.

FIG. 3 is a partly sectional side elevational view of a second embodiment of the engine device.

FIG. 4 is an end elevational view of the engine device according to FIG. 3.

FIGS. 5 and 6 are side elevational and top plan views of one of the pockets of the engine device.

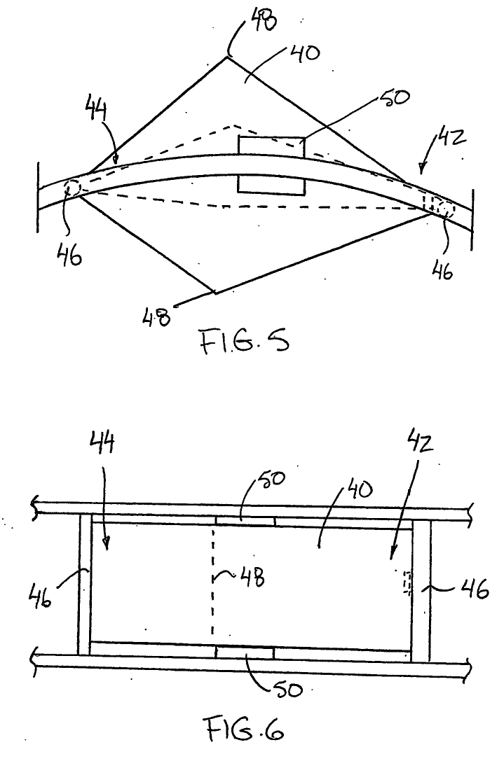

### DETAILED DESCRIPTION

Referring to the accompanying drawings, there is illustrated an engine device generally indicated by reference numeral 10. The engine device consumes compressed air from a suitable source of compressed gaseous air 12 to produce rotary, mechanical power at a rotary output drive member 14. The drive member 14 comprises a power take off shaft for rotating a pulley, gear or the like thereon for driving a generator or any other device desired to be driven with mechanical power.

While two embodiments are shown in the accompanying drawings, the common features of each will first be described herein in which like reference numerals in the figures correspond to similar parts.

The engine device includes a base 20 for being supported on the ground. The base supports a pair of upright supports 22 in a vertical, parallel and spaced apart relationship. A horizontal shaft 24 is supported for rotation about a respective longitudinal axis of the shaft which extends horizontally between the upright supports 22 perpendicularly thereto. Bearings 26 are provided on each of the upright supports 22 for rotatably supporting a respective end of the shaft 24 thereon.

A wheel 28 is mounted on the shaft between the upright supports 22 for rotation with the shaft about the horizontal axis. The wheel is arranged for rotation in a working direction to define a rising side 30 in which the periphery of the wheel moves upwardly and a falling side 32 in which the periphery of the wheel falls downwardly.

The wheel generally comprises a frame of tubes including a pair of circumferential tubes 34 at spaced positions about a periphery of the generally cylindrical shaped wheel 28. The circumferential tubes 34 are concentrically aligned with the shaft 24.

The shaft includes a pair of longitudinal bores 36 formed in opposed ends thereof which terminate at an interior of the shaft spaced from one another on opposing sides of a solid central portion of the shaft. A plurality of radial spokes 38 span between the circumferential tubes and the shaft for supporting the tubes in relation to the shaft 24. Each spoke 38 comprises a tube which communicates between a respective one of the circumferential tubes 34 and a respective one of the bores so that all spokes communicating with a given one of the circumferential tubes 34 communicate with the same one of the bores 36 in the shaft.

A plurality of pockets 40 are defined about the periphery of the wheel in the form of air bags which are sequentially located about the circumference of the frame of tubes, each spanning between the circumferential tubes 34. Accordingly the pockets 40 are radially spaced from the shaft. When rotated in the working direction each pocket includes a leading end 42 facing into the direction of travel and a trailing end 44 facing away from the direction of travel. Both ends 42 and 44 of the pockets are tapered so as to be reduced in profile in the circumferential direction for reducing drag as the wheel is rotated through a surrounding fluid. A shaft 46 spans between the circumferential tubes 34 at each end of each pocket for supporting the end of the pocket which is accordingly attached thereto. The inner and outer sides of the pockets generally comprise stiff panels flexibly joined with one another to be moveable between an expanded position having a large interior volume projecting outwardly to respective inner and outer apexes 48 and a deflated position in which the inner and outer sides are compressed adjacent one another to significantly reduce the interior volume of the pocket. Flexible sides are provided on each pocket such that the pocket forms a sealed enclosure.

Each pocket forms a sealed enclosure which includes a pair of solenoid valves 50 coupled in communication therewith for controlling communication of air with the interior of the pocket. Each valve, of the two valves belonging to each pocket, communicates with a respective one of the circumferential tubes. The solenoid valves 50 include suitable control wiring connected to a control mechanism which determines timing of the valves to control when air is introduced into the pockets respectively. Contacts may be provided on the shaft externally of the upright supports which include brushes which communicate with the contacts on the shaft so that the valves are opened and closed at specific points in the rotation of the wheels.

A tank 52 surrounds the wheel 28 to form an enclosure for containing fluid about the wheel. The tank includes a peripheral wall 54 which is cylindrical about the wheel axis but is spaced radially outwardly from the wheel and the pockets about the periphery thereof. Enclosed sides 56 are provided on the tank to fully surround the wheel. The wheel is spaced inwardly in the axial direction from the sides 56 of the tank as well as being spaced radially inwardly about the periphery relative to the peripheral wall 54.

At least one of the bores 36 and corresponding circumferential tube 34 to which it communicates with is connected to air supplied under pressure to co-operate with the respective solenoid valves of the pockets 40 in a manner such that timing of the valves ensures that air is only injected into the respective pockets on the rising side of the wheel near the bottom of rotation. The buoyancy of air injected into the pockets which are sealed with respect to the surrounding fluid contained by the tank causes the rising side to continue to be lifted for ensuring further rotation of the wheel. A compressor 58 supplies the air under pressure to said at least one bore for injection into the pockets. A buffer vessel may be provided between the compressor and the wheel for ensuring a relatively constant supply pressure.

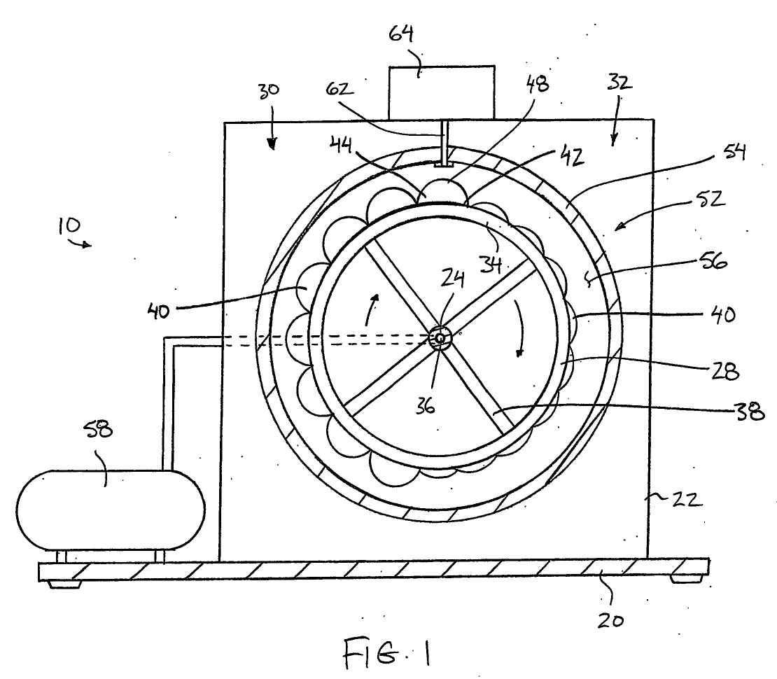

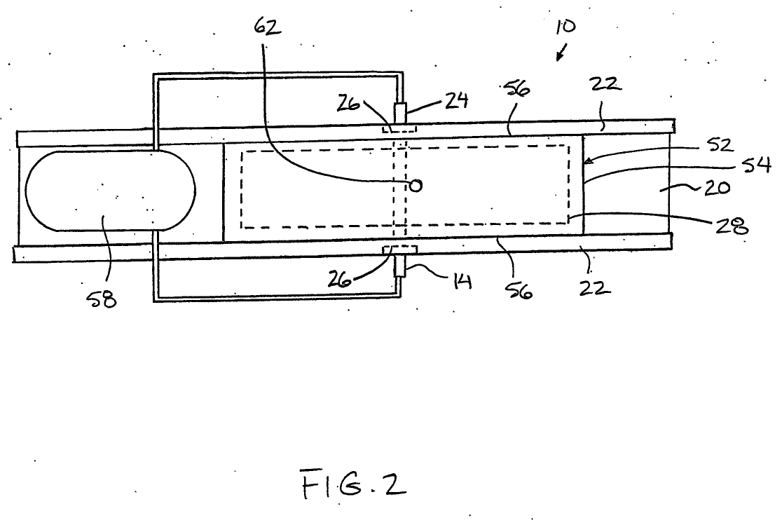

Turning now more specifically to the embodiment of FIGS. 1 and 2, the upright supports 22 comprise parallel and spaced apart vertical walls having a smooth interior surface. The peripheral wall 54 of the tank spans directly between the walls forming the upright supports 22 such that the upright supports form the enclosed sides 56 of the tank. Accordingly the tank walls are fixed relative to the base and the ground. The wheel is fixed on the shaft 24 which is rotatable relative to the tank. The bearings 26 in this instance are suitably arranged for containing the fluid sealed within the tank while permitting rotation of the shaft projecting through the bearings and through the tank walls. All of the interior surfaces of the peripheral wall and the upright supports 22 are smooth in this instance to reduce drag of water in motion within the tank as the wheel rotates.

In this embodiment air is supplied under pressure by the compressor to the bores 36 at both ends of the shaft and accordingly the supply pressure of air is also supplied to both circumferential tubes 34 and into each pocket through both respective solenoid valves 50 thereof. The valves on each bag are timed for operating together to both inject the air under pressure on the rising side of the wheel near the bottom of rotation. Air is released in this instance by an outlet valve 60 at the trailing end 44 of each bag. The outlet valve 60 is an opening which only permits gas to be released on the falling side of the wheel when the trailing end faces generally upwardly so that the compressed air within the pockets 40 can rise upwardly through the outlet valve 60 and subsequently collects at the top of the surrounding tank 52. As the air is released the pressure of the surrounding water forces the pocket to collapse on the falling side until air is once again injected into the respective pocket once the pocket passes the bottom of rotation and begins to rise on the rising side. A release valve is provided at the top of the tank 52 which communicates through a series of baffles to a gas collector 64. The baffles restrict water from splashing upwardly and from being carried by the collected compressed gas upwardly into the gas collector 64. The collected gas or air under pressure within the collector 64 can be reused for supplying gas under pressure to a second engine device of similar configuration coupled in series therewith.

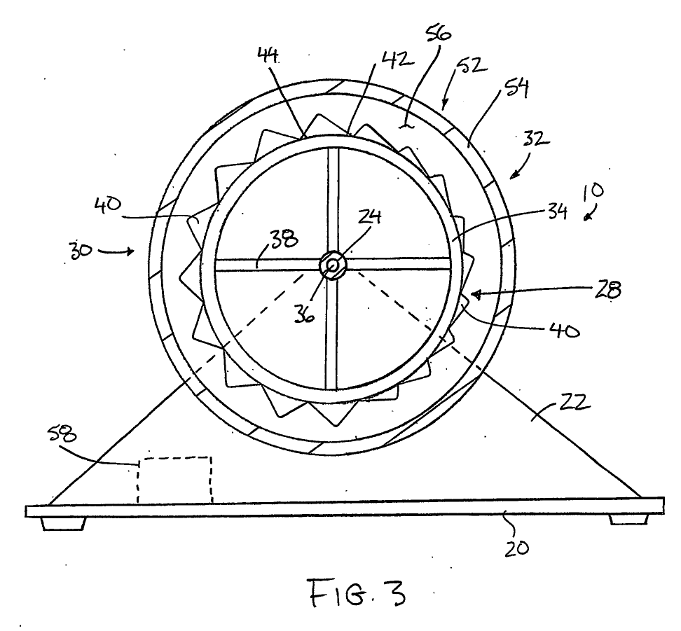

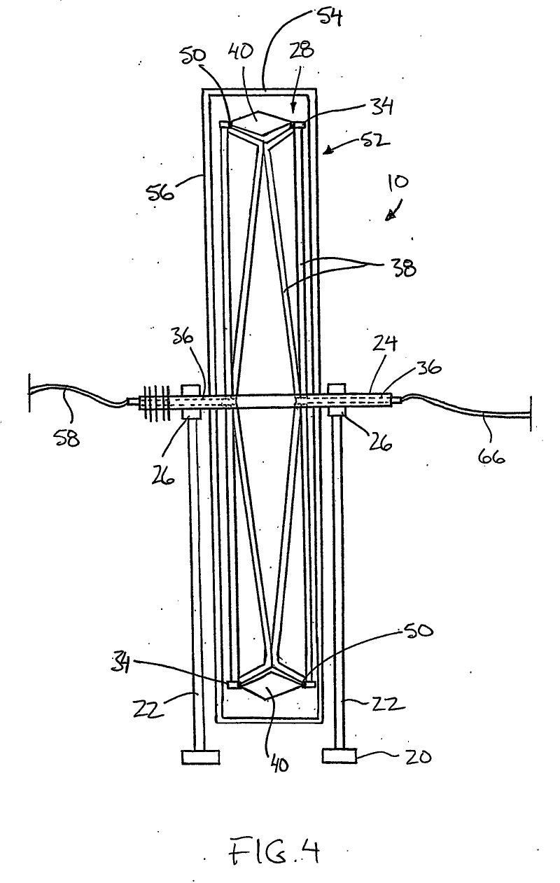

Turning now to FIGS. 3 and 4 a second embodiment of the engine device will now be descried in further detail. In the second embodiment the peripheral wall 54 and enclosed sides 56 of the tank form an enclosure which surrounds the wheel and which is similarly supported on the shaft for rotation relative to the ground. Both the wheel 28 and the tank 52 rotate with the shaft relative to the upright supports between which the tank and wheel are mounted. Bearings provided on the upright supports act similarly to many conventional bearings for rotatably supporting the shaft thereon. Pillow block type bearings are preferred.

In the second embodiment fluid within the tank fully surrounds the wheel including the spokes and circumferential tubes thereof so that the fluid rotates with the wheel and the surrounding tank to act as a large fly wheel. The pockets in this instance are fully sealed with respect to the surrounding fluid and do not communicate with the interior of the tank. Instead one of the bores 36 is provided for injecting air under pressure supplied thereto while the other bore 36 is connected to a source of vacuum pressure to draw air out of the pockets at the desired points of rotation. The vacuum pressure is supplied by a suitable vacuum pump connected to the respective bore 36 on the shaft through a suitable pressure vessel to provide a more constant vacuum pressure. In this instance air is supplied under pressure through one end of the shaft while the vacuum is connected through the opposing end of the shaft to draw air in and out of the pockets through opposing ends of the shaft. This design readily permits engine device to be connected in series for improving efficiency thereof.

Each of the pair of valves communicating with each pocket is accordingly communicated with either the supply under pressure or the vacuum while the other valve for that pocket communicates with the opposing one of the vacuum or air under pressure. Timing of the valves is selected so that air injection takes place on the rising side near the bottom of rotation while opening the valve to expose the pocket to the vacuum pressure occurs on the falling side near the top of rotation. In this arrangement the pockets on the falling side are always collapsed with the air or gas being substantially removed therefrom while the pockets on the rising side are always filled with gas or air under pressure to expand the pockets such that buoyancy of the pockets on the rising side forces continued rotation of the wheel to produce useable power at the drive shaft 14.

For typical operations, the fluid filling the tank 52 is typically a liquid, and more specifically would typically be water because of its convenience. Other fluids may be useful and advantageous however, for instance denser fluids including heavy water or solutions may be used, or varying temperatures of hot and cold fluid or gas may be used. Heaters or refrigeration equipment might be employed in this instance. Similarly the gas being injected will typically be ambient air from the atmosphere for sake of convenience, however through experimentation numerous other fluids or gases may be determined to operate more effectively.

In either embodiment operation is similar in which air is injected using valve timing of the solenoid valves 50 at the bottom of the rising side so that buoyancy of the expanded pockets filled with gas rotates the wheel in the working direction. Air is removed at the top of the falling side by either using solenoid valves 50 communicated to vacuum tubes or by providing a vent valve at the trailing end of the pocket to permit the gas to escape through the tank upwards to the gas collector.

In further arrangements a fly wheel may be provided of dense solid matter to increase the inertia of the spinning wheel. There may also be provided an electromagnetic coil supported on the wheel or magnets and the like or other means for generating a surrounding magnetic field in the tank so that a current may be generated when the wheel is rotated. In other arrangements the wheel may be electrically insulated from the surrounding environment by use of rubber insulators which isolate the upright supports 22 with respect to the ground. In this arrangement an electrical storage device is in communication with the wheel for collecting accumulation of static charges from the wheel.

The engine as described herein uses the forces of nature to create usable energy. The forces of nature being used here are buoyancy, gravity, air leverage force, drag and centrifugal force. There is no pollution as a by product of this energy source.

Since there is one air bag after another, the timing of the air injection is not crucial as there is always an air bag in position to capture the air. Under normal operation, the compressed air injection through the solenoid valves may be timed to fill only a portion of each pocket, or only some of the pockets might be filled, but if more torque is required, the injection is sped up to completely fill each pocket.

As each air bag is filled with air, its buoyancy spins the drum, moving the next air bag into position. As the air bags are on a drum, this moves them up and out always the same distance from the shaft. This creates a lever force proportional to distance of the bags from the shaft. The moment force gets greater as the bag moves up and out, the half way point up being the most powerful then diminishing as it rises to the top.

So by using lever force this way, the higher and longer the tank and air bag drum with tank and drum increasing in size equally, the more force is generated per unit volume of air. Such an analogy would be a beach ball on a two foot stick or a twenty foot stick and trying to push it under the water while holding onto the end opposite the beach ball. Width of the tank would never have to change as long as the air bags stay the same, you would just need more air bags.

As the air bags fill, collapse and spin through the water or fluid, this creates drag and causes the water to circulate in the same direction. Since there is no air being dispersed throughout the water it doesn't lose its buoyancy, thus the air bag full of air always stays ahead of the water, and efficiency improves.

As the water spins and creates drag on the outside of the tank, the drag could be used to spin an outer drum causing less drag. The outer drum could be supported on an outside shaft would produce more energy captured by inertia of the rotation body of water within the drum. The sides of the tank could possibly be used in the same way. Different fluids could be used as well, such as salt water, antifreeze or heavy water.

Other possible improvements in future research and development, could be the use of a solar heat pump to heat the fluid, thus causing the air to expand after injection.

In a further embodiment, the entire apparatus is insulated from electrical grounding so to be able to capture the static electrical build up in a grid box or battery system.

Tests have been completed on a 24 foot wheel, thus using a 12 foot lever force. While using 5 lbs. of compressed air captured in a 2 litre air bag. At the horizontal position in relation to the axis, 2 litres of air (5 lbs.) created 246 lbs. of torque on the axle. The air bag at the ten o'clock and eight o'clock positions created 242 lbs. of torque. When the air bag reached the position so to be using 10 feet of lever force it produced 177 lbs. of torque.

On a 24 foot wheel using 10 2 litre air bags filled with air, at 5 lbs. air times ten equals 50 lbs. of consumption to 1378 lbs. of torque. Of course by using a larger wheel such as a 25 foot radius lever or 4 or 8 litre air bags, this would increase the usable torque in relation to size and volume.

While various embodiments of the present invention have been described in the foregoing, it is to be understood that other embodiments are possible within the scope of the invention. The invention is to be considered limited solely by the scope of the appended claims.

1. An engine device comprising:
a wheel supported for rotation in a working direction about a generally horizontal wheel axis, defining a rising side and a failing side of the wheel as the wheel rotates;
a plurality of pockets at spaced positions about a periphery of the wheel;
a tank surrounding the wheel for containing a fluid about the wheel;
means to introduce gas into the pockets on the rising side of the wheel;
means to remove gas from the pockets on the falling side of the wheel;
and a power take-off shaft coupled to the wheel for rotation with the wheel about the wheel axis;
whereby buoyancy of gas in the pockets on the rising side of the wheel causes rotation of the wheel in the working direction to produce usable power at the power take-off shaft.

2. The engine device according to claim 1 wherein the pockets are spaced radially outward from the shaft.

3. The engine device according to claim 1 wherein each pocket tapers radially inwardly towards a leading side thereof.

4. The engine device according to claim 1 wherein the pockets are collapsible.

5. The engine device according to claim 1 wherein each pocket comprises a stiff outer panel coupled to the periphery of the wheel by flexible side members permitting the stiff outer panel to be displaced between an expanded position of the pocket in which the panel is spaced from the periphery of the wheel and a collapsed position of the pocket in which the panel is directly adjacent the periphery of the wheel.

6. The engine device according to claim 1 wherein the shaft is arranged to extend through a wall of the tank and wherein there is provided a sealing member connected between the wall and the shaft.

7. The engine device according to claim 1 wherein the tank has an outer wall which is generally cylindrical about the wheel axis, spaced outwardly from the periphery of the wheel.

8. The engine device according to claim 1 wherein the tank is supported for rotation about the wheel axis.

9. The engine device according to claim 1 wherein the means to introduce gas into the pockets comprises a source of gas under pressure which selectively communicates with each of the pockets.

10. The engine device according to claim 9 wherein there is provided a solenoid valve communicating between each pocket and the source of gas under pressure.

11. The engine device according to claim 9 wherein the wheel includes a plurality of radially extending tubes communicating between the pockets and the source of gas under pressure at a centre of the wheel.

12. The engine device according to claim 11 wherein the source of gas under pressure communicates through a shaft of the wheel.

13. The engine device according to claim 1 wherein the pockets are sealed with respect to fluid in the surrounding tank and wherein the means to introduce gas into the pockets and the means to remove gas from the pockets each comprise tubes communicating gas externally from the wheel.

14. The engine device according to claim 13 wherein the means to remove gas from the pockets comprises a source of vacuum pressure which selectively communicates with the pockets.

15. The engine device according to claim 14 wherein there is provided a solenoid valve communicating between each pocket and the source of vacuum pressure.

16. The engine device according to claim 13 wherein the means to introduce gas into the pockets includes an inlet bore at one end of the shaft of the wheel communicating with the pockets via selected ones of the tubes and wherein the means to remove gas from the pockets includes an outlet bore at an opposing end of the shaft of the wheel communicating with the pockets via selected other ones of the tubes.

17. The engine device according to claim 1 wherein the means to remove gas from the pockets comprises an outlet vent in each pocket located at a trailing end thereof.

18. The engine device according to claim 17 wherein there is provided a gas collector at a top end of the tank for collecting gas released by the pockets into the fluid contained in the tank.

19. The engine device according to claim 17 wherein the tank is fixed relative to the ground and the wheel is rotatable within the tank.
